(19) United States
(12) Patent Application Publication
(10) Pub. No.: US 2015/0123559 A1
(43) Pub. Date: May 7, 2015

(54) OPTICAL SEMICONDUCTOR LIGHTING APPARATUS

(71) Applicant: POSCO LED COMPANY LTD., Seongnam-si (KR)

(72) Inventors: Kyung-Rye KIM, Seongnam-si (KR); Ji Eun Kook, Seongnam-si (KR); Seon Min Park, Seongnam-si (KR)

(73) Assignee: POSCO LED COMPANY LTD., Seongnam-si (KR)

(21) Appl. No.: 14/143,473

(22) Filed: Dec. 30, 2013

Related U.S. Application Data
(60) Provisional application No. 61/901,189, filed on Nov. 7, 2013.

(51) Int. Cl. H05B 33/08

(52) U.S. Cl. CPC H05B 33/08
USPC 315/250

(57) ABSTRACT

An optical semiconductor lighting apparatus includes: a housing; a heat discharge block which is made of a metal and is embedded in the housing; an AC direct-connection module which is made of a metal and is embedded in the housing, the AC direct-connection module including a semiconductor optical device which is driven in an AC direct-connection scheme; and an insulation connector which is provided in the AC direct-connection module and is exposed to an outside of the housing for electrical connection with an external power source.

### CROSS REFERENCE TO RELATED APPLICATION

This application claims the benefit of U.S. Provisional Patent Application No. 61/901,189, filed on Nov. 7, 2013, which is hereby incorporated by reference for all purposes as if fully set forth herein.

### BACKGROUND OF THE INVENTION

1. Field of the Invention

The present invention relates to an optical semiconductor lighting apparatus, and more particularly, to an optical semiconductor lighting apparatus including a semiconductor optical device as a light source, which is driven in an AC direct-connection scheme, thereby improving heat dissipation efficiency and obtaining stable driving of the semiconductor optical device and circuits.

2. Description of the Related Art

As compared with incandescent bulbs and fluorescent lamps, optical semiconductors using a light source, such as a light-emitting diode (LED), an organic LED, a laser diode, and an organic electroluminescent diode, have low power consumption, long lifespans, superior durability, and high luminances. Due to these advantages, the optical semiconductors have recently attracted attention as illumination component.

An optical semiconductor light engine using such an optical semiconductor as a light source (hereinafter, referred to as a light engine) generally includes a housing of a predetermined size, an optical semiconductor embedded in the housing, a circuit unit configured to supply the optical semiconductor with power, and a heat sink of high thermal conductivity configured to discharge heat generated by the optical semiconductor. Electrical connection with the outside is made by a connector of a type specified by Zhaga (LED lighting engine standardization consortium).

Specifically, an AC/DC conversion-type light engine will be described with reference to FIGS. 9 and 10.

A conventional light engine specified by Zhaga (hereinafter, referred to as prior art), the exterior of which is illustrated in FIG. 9, includes a cylindrical body 410 and a terminal unit 240 configured to receive electrical signals from the outside of the body 410, that is, a connector of a type specified by Zhaga. The terminal unit 240 also has a shape specified by Zhaga, as illustrated, so that the other side protrudes a little further as compared with one side of its end.

The cylindrical body 410 includes a plurality of protrusions 320 arranged on its outer peripheral surface at a distance from each other, and the protrusions 320 are used to fit the body 410 into a holder (not illustrated).

Therefore, a light engine embedded with a circuit unit generally has an external size specified by the above-mentioned Zhaga. Thus, as far as the exterior is concerned, addition of a member other than those specified by Zhaga or other design change is prohibited.

However, the specification of Zhaga does not impose specific limitations regarding the design and arrangement structure of the interior of the body 410, which means that an AC/DC conversion type or any other type of a structure is allowed as long as electrical connection is made with the terminal unit 240, which is an insulation board, and, in the case of a light engine illustrated in FIG. 9, a circuit unit is embedded together with a light-emitting unit including at least one optical semiconductor.

In this regard, the light-emitting unit and the circuit unit can be separated from each other, or the light-emitting unit and the circuit unit can be formed integrally on a single insulation board.

The prior art will be described in more detail with reference to FIG. 10. A light-emitting device 100, which is the light-emitting unit, and a power unit module 200, which is the circuit unit, are separate from each other, and the power unit module 200 includes a single insulation board, as described above, thereby meeting the requirements of Zhaga that the connector be an insulation board.

However, such a structure, in which the light-emitting device 100 being the light-emitting unit is separate from the power unit module 200 being the circuit unit, has a problem that a design is complicated and heat dissipation performance of the power unit module 200 including an electronic device 220 such as an SMPS is degraded.

In other words, the prior art has limitations concerning its structural characteristics as follows: the light-emitting device 100 includes, as illustrated, a board 110 mounted on a top surface of a mounting portion 310 protruding from a central portion of a support unit 300 acting as a heat sink, so that heat generated by the light-emitting device 100 can be discharged, but the structural characteristics of the support unit 300 make it impossible to discharge heat generated by the power unit module 200, which includes an electronic device 220 and other types of components mounted along the periphery of the light-emitting device 100.

Even in the case of a structure having the light-emitting unit and the circuit unit integrally formed on a single insulation board, as is obvious to those skilled in the art, application of various circuit components inevitably degrades heat dissipation performance due to dense arrangement of such circuit components.

When the light-emitting unit and the circuit unit are integrally formed on a single insulation board as described above, the heat sink needs to have a wide and thick base, in order to prevent degradation of heat dissipation performance, making it impossible to make the light engine lightweight and compact.

In addition, when the light-emitting unit and the circuit unit are separate from each other, or when the light-emitting unit and the circuit unit are integrally formed on an FR4 PCB, an insulation pad is used in either case to electrically insulate between the board and the heat sink, greatly degrading the heat dissipation performance of the circuit unit.

A type of light engine may be considered in an effort to solve such problems, which includes a light-emitting unit and a circuit unit integrally formed on a heat-dissipation metal board and which is equipped with an AC direct-connection module including a drive IC configured to drive the light-emitting unit in an AC direct-connection scheme.

However, such a type of light engine, which includes a light-emitting unit and a circuit integrally formed on a heat-dissipation metal substrate, has a problem in that it cannot meet the requirements of Zhaga that the connector be an insulation board.

### SUMMARY OF THE INVENTION

The present invention has been made in an effort to solve the above problems, and is directed to provide an optical semiconductor lighting apparatus having improved heat dissipation efficiency and stable driving of semiconductor optical devices and circuits.

The present invention is also directed to provide an optical semiconductor lighting apparatus capable of guaranteeing a long lifespan and electrical stability while providing a product conforming to designated specifications.

The present invention is also directed to provide an optical semiconductor lighting apparatus capable of reducing the weight of the apparatus and reducing costs.

According to an aspect of the present invention, an optical semiconductor lighting apparatus includes: a housing; a heat discharge block which is made of a metal and is embedded in the housing; an AC direct-connection module which is made of a metal and is embedded in the housing, the AC direct-connection module including a semiconductor optical device which is driven in an AC direct-connection scheme; and an insulation connector which is provided in the AC direct-connection module and is exposed to an outside of the housing for electrical connection with an external power source.

The insulation connector includes: a connection piece which comes into surface contact with the heat discharge block together with the AC direct-connection module; a terminal piece which extends from the connection piece and is exposed to the outside of the housing; and at least one conductive wire which electrically connects the connection piece and the AC direct-connection module for electrical connection between the AC direct-connection module and the terminal piece.

The insulation connector may include: a surface mounted technology (SMT) piece which is mounted on a surface of the AC direct-connection module; and a terminal piece which extends from the SMT piece, is exposed to the outside of the housing, and is electrically connected to the AC direct-connection module.

The insulation connector may include: a first connector which is provided in the AC direct-connection module; a second connector which is detachably connected to the first connector; and a terminal piece which has one end provided with the second connector, and the other end exposed to the outside of the housing.

The insulation connector may include: a cutout portion which is formed on one side of the AC direct-connection module; a terminal piece which has one end connected to the cutout portion, and the other end exposed to the outside of the housing; and a connector which connects a periphery of the cutout portion and the one end of the terminal piece.

The connector may include: a first connector which is provided in the AC direct-connection module; and a second connector which is provided in the one end of the terminal piece and connected to the first connector.

The insulation connector may include: a third connector which is provided in the AC direct-connection module; and a terminal piece which has a connection terminal on one end, the connection terminal being connected to the third connector, and the other end exposed to the outside of the housing.

The one end of the terminal piece may be contacted on the AC direct-connection module.

The AC direct-connection module may include: a light source unit in which a plurality of semiconductor optical devices are arrayed; and a circuit unit including a drive IC which drives the semiconductor optical devices in the AC direct-connection scheme, the light source unit and the circuit unit being formed integrally.

The optical semiconductor lighting apparatus may further include: a light source unit in which a plurality of semiconductor optical devices are arrayed in a center portion of the AC direct-connection module; and a circuit unit which is arrayed around the light source unit, wherein the circuit unit may include: a drive IC which drives the semiconductor optical devices in the AC direct-connection scheme; a surge circuit; a temperature and overvoltage protection circuit; and a dimming control circuit.

A bottom of the AC direct-connection module may come into direct contact with a top surface of the heat discharge block.

The AC direct-connection module may come into contact with an entire surface of the heat discharge block.

The optical semiconductor lighting apparatus may further include: a light source unit in which a plurality of semiconductor optical devices are arranged on the AC direct-connection module; and a reflector which has a lower end surrounding a periphery of the light source unit and an upper end embedded in the housing, and has a shape gradually widening from the lower end towards the upper end.

The housing may be made of a transparent material.

In addition, the term “semiconductor optical device” as used in claims and detailed description refers to an LED chip or the like that includes or uses optical semiconductor.

The “semiconductor optical device” may include a package-level device with various types of optical semiconductor as well as the above-mentioned LED chip.

### BRIEF DESCRIPTION OF THE DRAWINGS

FIG. 1 is a cross-sectional conceptual diagram illustrating an overall configuration of an optical semiconductor lighting apparatus according to an embodiment of the present invention.

FIG. 2 is a top conceptual diagram illustrating a connection structure between an AC direct-connection module and an insulation connector, which are major components of the present invention, when seen from a view point A of FIG. 1.

FIG. 3 to FIG. 8 are conceptual diagrams illustrating connection structures between an AC direct-connection module and an insulation connector, which are major components of optical semiconductor lighting apparatuses according to various embodiments of the present invention, respectively.

FIG. 9 is a perspective view illustrating an exterior of an optical semiconductor lighting apparatus according to the prior art.

FIG. 10 is an exploded perspective view illustrating an overall configuration of an optical semiconductor lighting apparatus according to the prior art.

### DETAILED DESCRIPTION OF EXEMPLARY EMBODIMENTS

The advantages and features of the present invention and methods for achieving them will become more apparent from embodiments to be described below in detail in conjunction with the accompanying drawings.

However, the present invention is not limited to the embodiments set forth below, and can be implemented in various forms.

These embodiments are provided so that this disclosure will be thorough and complete, and will fully convey the scope of the present invention to those skilled in the art.

The scope of the present invention will be defined by only the appended claims.

Therefore, in some embodiments, detailed descriptions of related known functions or configurations will be omitted if they are considered to unnecessarily obscure the gist of the present invention.

Throughout the disclosure, like reference numerals refer to like parts throughout the drawings and embodiments of the present invention. The terms used (mentioned) in the present application are merely used to describe particular embodiments, and are not intended to limit the present invention.

An expression used in the singular encompasses the expression of the plural, unless it has a clearly different meaning in the context. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

Hereinafter, exemplary embodiments of the present invention will be described with reference to the accompanying drawings.

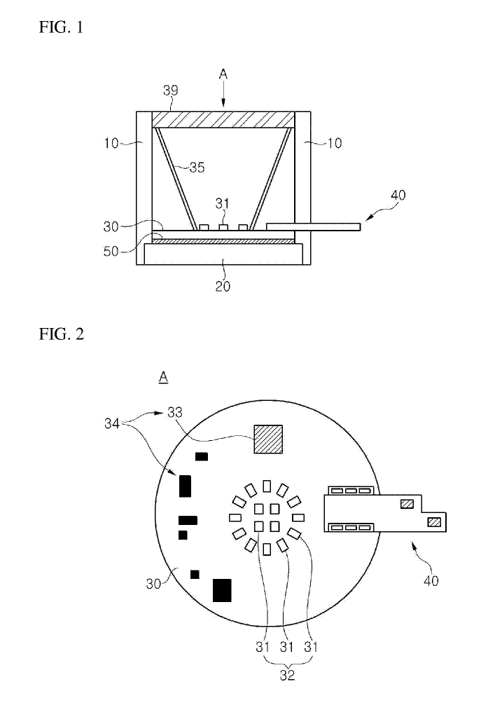

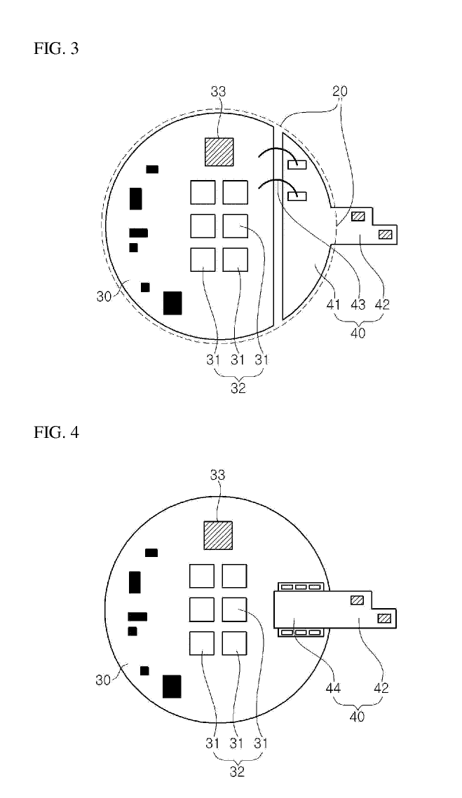

FIG. 1 is a cross-sectional conceptual diagram illustrating an overall configuration of an optical semiconductor lighting apparatus according to an embodiment of the present invention; FIG. 2 is a top conceptual diagram illustrating a connection structure between an AC direct-connection module and an insulation connector, which are major components of the present invention, when seen from a view point A of FIG. 1; and FIG. 3 to FIG. 8 are conceptual diagrams illustrating connection structures between an AC direct-connection module and an insulation connector, which are major components of optical semiconductor lighting apparatuses according to various embodiments of the present invention, respectively.

In FIG. 1, reference numeral 39 represents an optical plate, and reference numeral 50 represents a thermal pad.

It can be understood by those skilled in the art that a heat discharge block 20, an AC direct-connection module 30, and an insulation connector 40 are provided in a housing 10.

The housing 10 defines an inner space in which the heat discharge block 20, the AC direct-connection module 30, and the insulation connector 40 (described below) are to be mounted.

The heat discharge block 20 is made of a metal and is embedded in the housing 10. More specifically, the heat discharge block 20 constitutes the bottom of the housing 10, which has openings in the upper and lower ends, and is regarded as a kind of a heat sink configured such that heat is discharged from a semiconductor optical device 31 (described below) at high thermal conductivity.

The heat discharge block 20 can be made of any metal material of high thermal conductivity. However, in consideration of costs, the heat discharge block 20 may be made of aluminum or an aluminum alloy.

The AC direct-connection module 30 is embedded in the housing 10. The AC direct-connection module 30 is made of a metal and includes a semiconductor optical device 31 driven in an AC direct-connection scheme. The AC direct-connection module 30 comes into contact with the top surface of the heat discharge block 20 over a large area via a thermal pad 50 or thermal grease, thereby improving heat dissipation performance.

The insulation connector 40 is provided in the AC direct-connection module 30 and is exposed to the outside of the housing 10 for electrical connection with the outside.

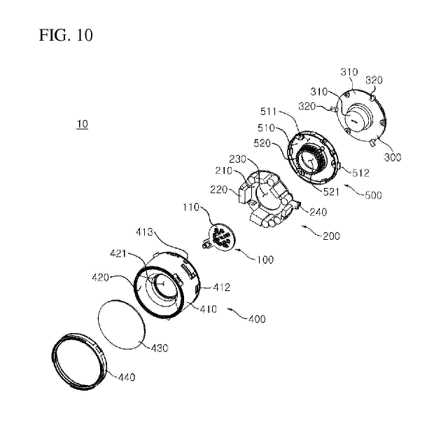

Therefore, the present invention is provided as a module for a lighting apparatus of an AC direct-connection scheme. Thus, as compared with a conventional lighting apparatus adopting a DC SMPS, unnecessary circuit components such as the power unit module 200 (see FIG. 10) can be omitted, thereby making the entire apparatus lightweight and reducing the manufacturing cost.

Particularly, according to the present invention, the AC direct-connection module 30 adopted in the lighting apparatus of the AC direct-connection scheme is electrically connected to the insulation connector 40, which is an insulation board specified by Zhaga, so that the degree of freedom of design is provided by the AC direct-connection module 30, which is simplified as mentioned above, while meeting requirements regarding the exterior of the light engine specified by Zhaga.

In addition to the embodiment of the above-described configuration, various embodiments can also be applied according to the present invention, as will be described below.

The AC direct-connection module 30 is provided with a light source unit 32 in which a plurality of semiconductor optical devices 31 are arrayed, and a circuit unit 34 including a drive IC 33 configured to drive the semiconductor optical devices 31 in the AC direct-connection scheme. As described above, the light source unit 32 and the circuit unit 34 are integrally arrayed to lessen the problem of heat dissipation, which results from dense arrangement of components, to some extent.

Alternatively, the light source unit 32 can include a plurality of semiconductor optical devices 31 arrayed in the central portion of the AC direct-connection module 30, as illustrated in FIG. 2, and the circuit unit 34 can be arrayed around the light source unit 32.

The circuit unit 34 can include, in addition to the drive IC 33, a surge circuit, a temperature and overvoltage protection circuit, and a dimming control circuit.

According to another embodiment of the present invention, the optical semiconductor lighting apparatus may further include a reflector 35. The reflector 35 is disposed around the light source unit 32 including a plurality of semiconductor optical devices 31, has a lower end surrounding the periphery of the light source unit 32 and an upper end embedded in the housing 10, and has a shape gradually widening from the lower end towards the upper end.

The reflector 35 can be considered as technical means for changing the direction of light irradiated from the light source unit 32.

The housing 10 can also be made of a transparent material so that a light distribution area is increased by transmit or refract light irradiated from the reflector 35 in various directions.

On the other hand, as described above, the insulation connector 40 is connected to the AC direct-connection module 30 for electrical connection with the outside. According to an embodiment illustrated in FIG. 3, the insulation connector 40 includes a connection piece 41, a terminal piece 42, and a conductive wire 43.

The connection piece 41 comes into surface contact with the heat discharge block 20 together with the AC direct-connection module 30, and the terminal piece 42 extends from the connection piece 41 and is exposed to the outside of the housing 10.

The conductive wire 43 is at least one member configured to electrically connect the connection piece 41 and the AC direct-connection module 30 for the purpose of electrical connection between the AC direct-connection module 30 and the terminal piece 42.

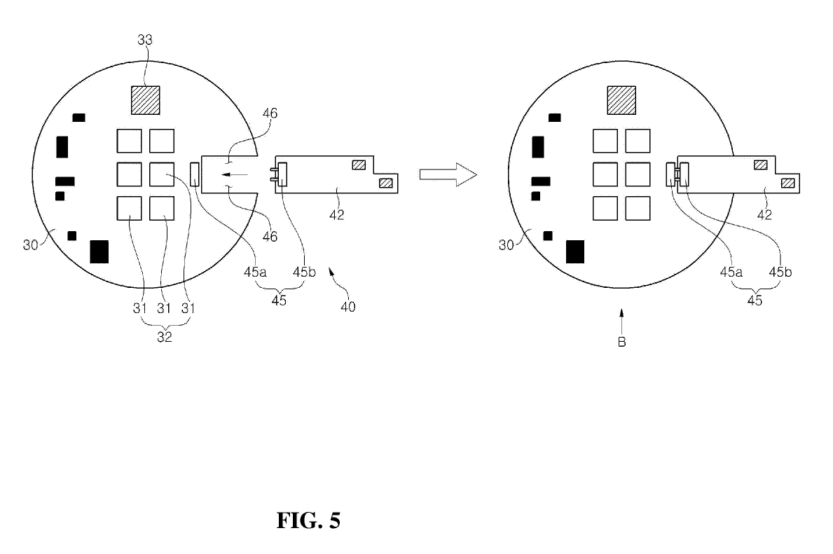

In addition, according to another embodiment illustrated in FIG. 4, the insulation connector 40 includes a surface mounted technology (SMT) piece 44 and a terminal piece 42. The SMT piece 44 is mounted on the surface of the AC direct-connection module 30. The terminal piece 42 extends from the SMT piece 44, is exposed to the outside of the housing 10, and is electrically connected to the AC direct-connection module 30.

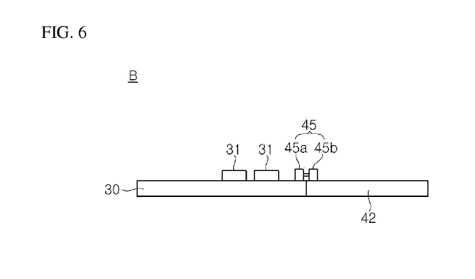

According to another embodiment illustrated in FIG. 5 and FIG. 6, the insulation connector 40 includes a terminal piece 42 having one end connected to a cutout portion 46, which is formed on one side of the AC direct-connection module 30, and the other end exposed to the outside of the housing 10, and a connector 45 connecting the periphery of the cutout portion 46 with one end of the terminal piece 42.

The connector 45 includes a first connector 45a provided in the AC direct-connection module 30, and a second connector 45b provided in one end of the terminal piece 42 and connected to the first connector 45a.

The first connector 45a functions as a female connector configured to receive the second connector 45b, which is provided with pins. The second connector 45b functions as a male connector inserted into the first connector 45a.

Although not illustrated, it is also possible to modify and apply the design such that the first connector 45a is provided with pins, and the second connector 45b functions as a female connector configured to receive the pins of the first connector 45a when the terminal piece 42 is detached and attached thereto.

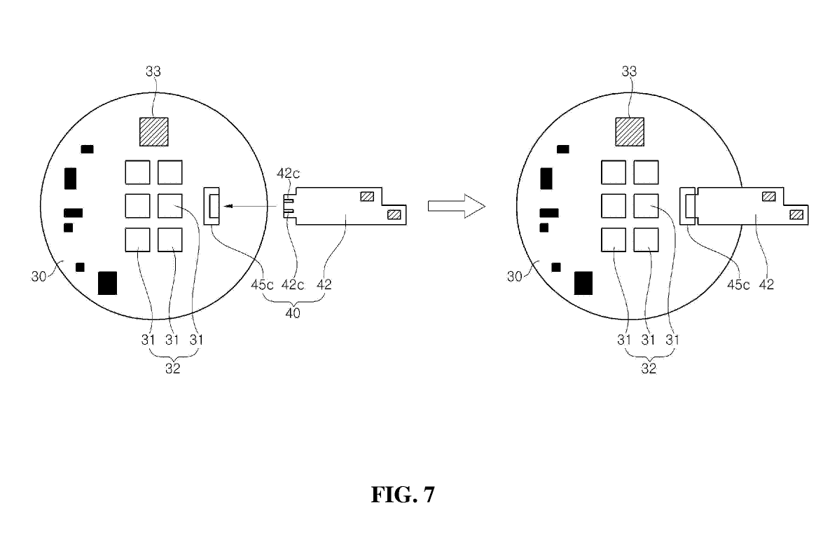

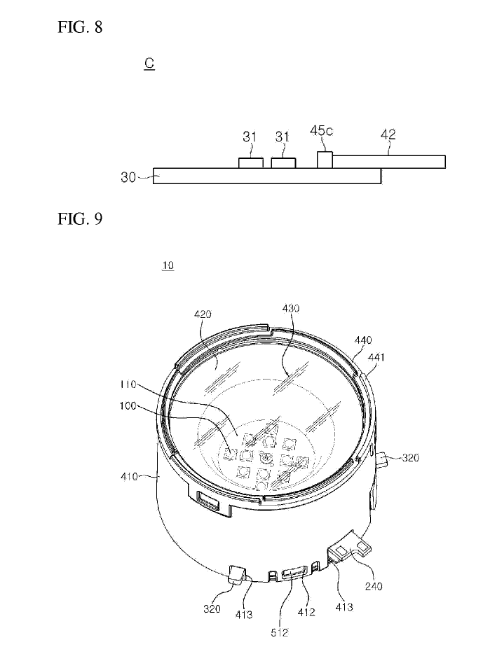

On the other hand, according to another embodiment illustrated in FIGS. 7 and 8, the insulation connector 40 includes a third connector 45c provided in the AC direct-connection module 30, and a terminal piece 42 having a connection terminal 42c on one end to be connected to the third connector 45c while the other end is exposed to the outside of the housing 10.

One end of the terminal piece 42 is contacted on the AC direct-connection module 30.

As described above, the basic technical idea of the present invention is to provide an optical semiconductor lighting apparatus having improved heat dissipation efficiency and stable driving of the semiconductor optical device and the circuits.

The above-described configurations according to the present invention can obtain the following effects.

First, the AC direct-connection module comes into surface contact with the top surface of the heat discharge block, thereby improving heat dissipation performance.

According to the present invention, the light source unit, which includes the semiconductor optical devices, and the circuit unit, which includes the drive IC for driving the semiconductor optical devices in the AC direct-connection scheme, are integrally arrayed on the single AC direct-connection module, thereby simplifying the structure of the light engine.

In addition, the present invention is provided as the module for the lighting apparatus of the AC direct-connection scheme so that, as compared with the conventional lighting apparatus adopting the DC SMPS, the number of circuit components is significantly reduced, making the overall apparatus lightweight and reducing the manufacturing cost.

In particular, the present invention applies various embodiments of connecting the AC direct-connection module and the insulation connector, while observing specifications of Zhaga regarding the exterior of the light engine and the connector, including the insulation substrate, thereby providing a product satisfying various consumer demands.

While the embodiments of the present invention have been described with reference to the specific embodiments, it will be apparent to those skilled in the art that various changes and modifications may be made without departing from the spirit and scope of the invention as defined in the following claims.

What is claimed is:

1. An optical semiconductor lighting apparatus, comprising:
a housing;
a metallic heat discharge block disposed in the housing; and
a metallic AC direct-connection module disposed in the housing and on the heat discharge block, the AC direct-connection module comprising:
semiconductor optical devices; and
an insulated connector exposed outside of the housing and configured to electrically connect the optical device with an external power source.

2. The optical semiconductor lighting apparatus of claim 1, wherein the insulated connector comprises:
a connection piece contacting the surface of the heat discharge block;
a terminal piece extending from the connection piece and outside of the housing; and
a conductive wire electrically connecting the connection piece and the AC direct-connection module.

3. The optical semiconductor lighting apparatus of claim 1, wherein the insulated connector comprises:
a surface mounted technology (SMT) piece disposed on a surface of the AC direct-connection module; and
a terminal piece extending from the SMT piece and outside of the housing, the terminal piece being electrically connected to the AC direct-connection module.

4. The optical semiconductor lighting apparatus of claim 1, wherein the insulated connector comprises:
a terminal piece having a first end an opposing second end;
a first connector disposed on the AC direct-connection module; and
a second connector disposed on the first end of the terminal piece and configured to detachably connect to the first connector, wherein the second end of the terminal piece is disposed outside of the housing when the second connector is connected to the first connector.

5. The optical semiconductor lighting apparatus of claim 1, wherein the insulated connector comprises:
a cutout portion disposed on one side of the AC direct-connection module;
a terminal piece having a first end connected to the cutout portion, and a second end disposed outside of the housing; and
a connector connecting a periphery of the cutout portion and the first end of the terminal piece.

6. The optical semiconductor lighting apparatus of claim 5, wherein the connector comprises:
a first connector disposed on the AC direct-connection module; and
a second connector disposed on the first end of the terminal piece and connected to the first connector.

7. The optical semiconductor lighting apparatus of claim 1, wherein the insulated connector comprises:
a first connector disposed on the AC direct-connection module; and
a terminal piece having a first end and an opposing second end, the terminal piece comprising a connection terminal disposed on the first end,
wherein when the connection terminal is connected to the first connector, the first end is disposed directly on the AC direct-connection module, and the second end is exposed outside of the housing.

8. The optical semiconductor lighting apparatus of claim 7, wherein the first end has a smaller width than a central portion of the terminal piece.

9. The optical semiconductor lighting apparatus of claim 1, wherein the AC direct-connection module comprises:
a plurality of the semiconductor optical devices disposed on a central portion of the AC direct-connection module; and
a circuit unit disposed outside of the central portion of the AC direct-connection module.

10. The optical semiconductor lighting apparatus of claim 9, wherein the circuit unit comprises:
a drive IC configured to drive the semiconductor optical devices using the AC voltage;
a surge circuit;
a temperature and overvoltage protection circuit; and
a dimming control circuit.

11. The optical semiconductor lighting apparatus of claim 1, wherein the AC direct-connection module directly contacts the heat discharge block.

12. The optical semiconductor lighting apparatus of claim 1, wherein the AC direct-connection module completely covers an entire upper surface of the heat discharge block.

13. The optical semiconductor lighting apparatus of claim 1, further comprising:
a plurality of the semiconductor optical devices disposed on the AC direct-connection module; and
a conical reflector disposed in the housing and configured to reflect light from the semiconductor optical devices away from the AC direct-connection module.

14. The optical semiconductor lighting apparatus of claim 1, wherein the housing is at least partially transparent.

15. An optical semiconductor lighting apparatus, comprising:
a housing;
a heat discharge block disposed in the housing; and
an alternating current (AC) direct-connection module disposed in the housing and on the heat discharge block, the AC direct-connection module comprising at least one semiconductor optical device; and
an insulated connector exposed outside of the housing and detachably connected to the AC direct-connection module.

16. The optical semiconductor lighting apparatus of claim 15, wherein the AC direct-connection module comprises a conductive material.

17. The optical semiconductor lighting apparatus of claim 16, wherein the insulated connector comprises a conductive connector disposed thereon, and
wherein the insulated connector is electrically connected to the AC direct-connection module through the conductive connector.

18. The optical semiconductor lighting apparatus of claim 17, wherein the insulated connector comprises a terminal piece configured to electrically connect the at least one semiconductor optical device with an external power source.

19. The optical semiconductor lighting apparatus of claim 18, wherein the insulated connector comprises a connector piece connected to the terminal piece, and
wherein the conductive connector is disposed on the connector piece.

20. The optical semiconductor lighting apparatus of claim 19, wherein the connector piece is disposed on the AC direct-connection module.
